(19) United States
(12) Patent Application Publication
(10) Pub. No.: US 2009/0168333 A1
(43) Pub. Date: Jul. 2, 2009

(54) INFORMATION PROCESSING APPARATUS AND FAN CONTROL METHOD

(75) Inventors: Toshimitsu Saito, Fuchu-shi (JP); Yoshihisa Suzuki, Fussa-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/204,729

(22) Filed: Sep. 4, 2008

(30) Foreign Application Priority Data
Dec. 27, 2007 (JP) 2007-338242

(51) Int. Cl. G06F 1/20; G05D 23/00

(52) U.S. Cl. 361/679.48; 318/471

(57) ABSTRACT

According to one embodiment, an information processing apparatus includes: a case; a device that is housed in the case; a cooling fan that cools the device; a temperature detecting device that detects a temperature of the device; and a controller that is operable in a first mode and second mode, the first mode controlling the cooling fan in a range from a stopped state to a given rotation speed in accordance with the temperature detected by the temperature detecting device, and a second mode controlling the cooling fan to rotate at a predetermined rotation speed that is lower than the given rotation speed.

### CROSS-REFERENCE TO RELATED APPLICATIONS

This application is based upon and claims the benefit of priority from Japanese Patent Application No. 2007-338242, filed Dec. 27, 2007, the entire contents of which are incorporated herein by reference.

### BACKGROUND

1. Field

One embodiment of the invention relates to a technique for controlling a fan of an information processing apparatus, and more particularly, to an information processing apparatus, which is switchable to a mode for suppressing a rotation noise of a fan, and a fan control method.

2. Description of the Related Art

Generally, in a person computer, a cooling process of a device is performed using a motor cooling fan. For example, as shown in JP-A-08-328698, there is disclosed a technique in which when a power supply to a note-type computer is an AC power supply, a cooling process is performed by rotation of a cooling fan, and when the power supply is a battery, the rotation of the cooling fan is stopped to decrease a process speed of a CPU so as to suppress heating. Recently, difference in power consumption between a mode of precipitous performance-up according to a dual core of a CPU and a low-load mode that is a standstill state of a CPU is getting larger, and the case of switching the modes even at a battery operating time is increasing. In addition, although performance is pursued even at the battery operating time, a long time operation is also required.

However, in the technique described in JP-A-08-328698, prioritizing a decrease in process speed of the CPU at the battery operating time, it is difficult to exhibit performance. In addition, since the fan is constantly turned off due to taking a serious view of power saving, a fan control cannot follow an increase in temperature caused by precipitous performance-up after return of the CPU processing speed, in a state where temperature in a PC rises by a graphics controller other than the CPU. Moreover, the fan repeats turning on and off, and thus a noise harsh to user's ears is generated by change in the number of rotation, stoppage of the cooling fan, or restart of rotation.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view illustrating an appearance of an information processing apparatus according to an embodiment.

FIG. 2 is an exemplary block diagram illustrating an example of a system configuration of the information processing apparatus shown in FIG. 1.

FIG. 3 is an exemplary block diagram illustrating a system configuration for controlling the number of rotation of a fan provided in the information processing apparatus shown in FIG. 1.

FIG. 4 is an exemplary flowchart illustrating a sequence of a fan control method according to an embodiment.

FIG. 5 is an exemplary schematic diagram illustrating a utility of fan control setup according to an embodiment.

FIG. 6 is an exemplary schematic diagram illustrating a utility of fan control setup according to an embodiment.

FIG. 7 is an exemplary schematic diagram illustrating a utility of fan control setup according to an embodiment.

FIG. 8 is an exemplary schematic diagram illustrating a utility of fan control setup according to an embodiment.

FIG. 9 is an exemplary schematic diagram illustrating a utility of fan control setup according to an embodiment.

### DETAILED DESCRIPTION

Various embodiments according to the invention will be described hereinafter with reference to the accompanying drawings. In general, according to one embodiment of the invention, there is provided an information processing apparatus including: a case; a device that is housed in the case; a cooling fan that cools the device; a temperature detecting device that detects a temperature of the device; and a controller that is operable in a first mode and second mode, the first mode controlling the cooling fan in a range from a stopped state to a given rotation speed in accordance with the temperature detected by the temperature detecting device, and a second mode controlling the cooling fan to rotate at a predetermined rotation speed that is lower than the given rotation speed.

According to another embodiment of the invention, there is provide a method for controlling a cooling fan provided in an information processing apparatus having a case, a device housed in the case, the cooling fan cooling the device and a temperature detecting device detecting a temperature of the device, the method including: detecting a temperature of the device; and switching a first mode and second mode, the first mode controlling the cooling fan in a range from a stopped state to a given rotation speed in accordance with the temperature, and a second mode controlling the cooling fan to rotate at a predetermined rotation speed that is lower than the given rotation speed.

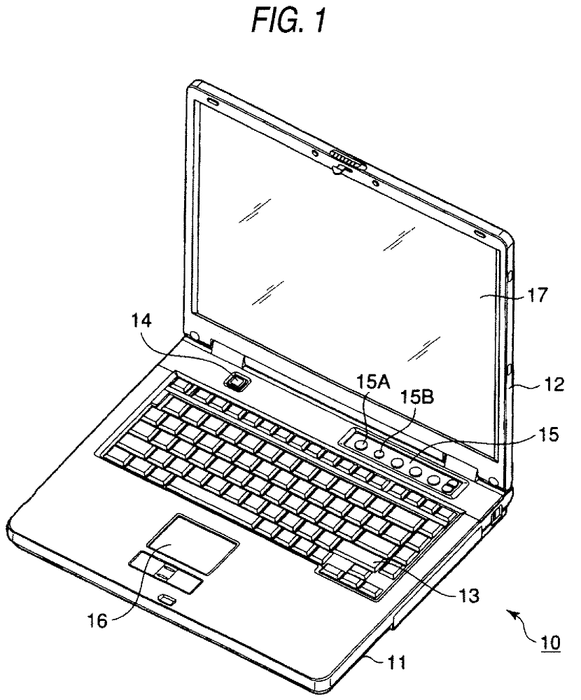

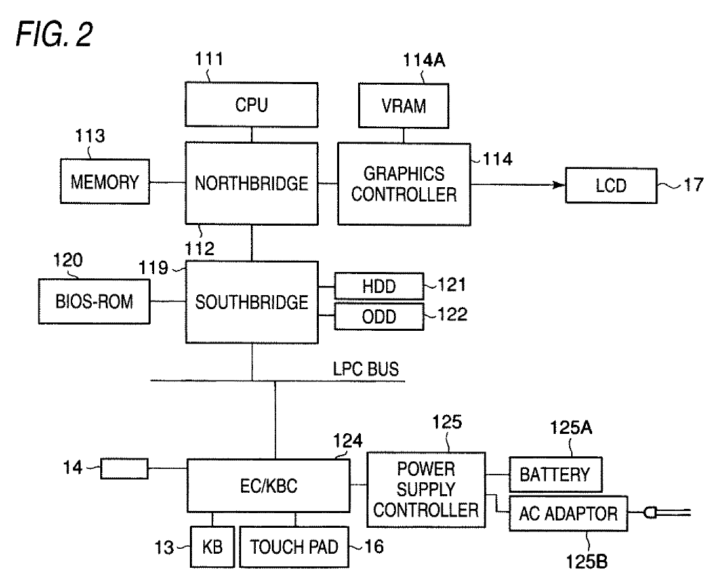

Referring to FIGS. 1 and 2, a configuration of an information processing apparatus according to an embodiment of the invention will be described. The information processing apparatus is embodied by a battery-operable portable notebook personal computer 10.

FIG. 1 is a perspective view illustrating a notebook personal computer 10 with a display unit opened. The computer 10 includes a computer body 11 and a display unit 12. The display unit 12 is provided with a display device including a LCD (Liquid Crystal Display) 17, and a display screen of the LCD 17 is located substantially at the center of the display unit 12.

The display unit 12 is attached to the computer body 11 so as to rotate between an open position and a close position. The computer body 11 has a thin box-shaped case, and a keyboard 13, a power button 14 for powering on/off the computer 10, an input operation panel 15, a touch pad 16, and the like are disposed thereon.

The input operation panel 15 is a device for inputting an event corresponding to a pressed button, and is provided with a plurality of buttons for starting a plurality of functions. This button group also includes a TV starting button 15A and a DVD/CD starting button 15B. The TV starting button 15A is a button for reproducing TV broadcasting program data. When a user presses the TV starting button 15A, an application program for reproducing TV broadcasting program data is automatically started. The DVD/CD starting button 15B is a button for reproducing video contents recorded on a DVD or a CD. When a user presses the DVD/CD starting button 15B, an application program for reproducing video contents is automatically started.

To display movies corresponding to TV broadcasting program data and movie data such as video contents in high video quality on the LCD 17, the computer 10 of the present embodiment has a function of automatically improving video quality of the moves at the time of reproducing movie data.

Referring to FIG. 2, a system configuration of the computer 10 will be described.

As shown in FIG. 2, the computer 10 includes a CPU 111, a northbridge 112, a main memory 113, a graphics controller 114, a southbridge 119, a BIOS-ROM 120, a hard disk drive (HDD) 121, an optical disk drive (ODD) 122, an embedded controller/keyboard controller IC (EC/KBC) 124, and the like.

The CPU 111 is a processor for controlling operations of the computer 10 and executes an operating system (OS) and various kinds of application programs, which as loaded from the hard disk drive (HDD) 121 to the main memory 113. The OS has a window system for displaying a plurality of windows on a display screen.

The CPU 111 also executes a system BIOS (Basic Input Output System) stored in the BIOS-ROM 120. The system BIOS is a program for controlling hardware.

The northbridge 112 is a bridge device connecting a local bus of the CPU 111 and the southbridge 119 to each other. A memory controller that accesses the main memory 113 is built in the northbridge 112. In addition, the northbridge 112 has a function of communicating with the graphics controller 114 through an AGP (Accelerated Graphics Port) bus or the like.

The graphics controller 114 is a display controller for controlling the LCD 17 used as a display monitor of the computer 10. The graphics controller 114 has a video memory (VRAM) and generates a video signal forming a display image to be displayed on the LCD 17, from display data described in the video memory by the O/S application program. Generally, the display image to be displayed on the LCD 17 is formed of an image of a desktop picture and images of windows disposed on the desktop picture. However, when a movie is displayed in a full screen mode, the display image to be displayed on the LCD 17 is formed only of an image of the movie. Accordingly, when the movie is displayed in the full screen mode, a video signal forming only the display image of the movie is output from the graphics controller 114.

The southbridge 119 controls devices on an LPC (Low Pin Count) bus. The southbridge 119 has an IDE (Integrated Drive Electronics) controller for controlling the HDD 121 and the ODD 122 therein. In addition, the southbridge 119 also has a function of access-controlling the BIOS-ROM 120.

The embedded controller/keyboard controller IC (EC/KBC) 124 is one-chip microcomputer in which an embedded controller for power supply control and heat radiation control and a keyboard controller for controlling a keyboard (KB) 13 and a touch pad 16 are integrated. The embedded controller/keyboard controller (EC/KBC) 124 has a function of power on/power off of the computer 10 according to operation of the power button 14 by a user.

The semiconductor devices such as the CPU 111, the northbridge 112, the southbridge 119, and the graphics controller 114 has a large amount of heat radiation, and thus a cooling fan is mounted. Even in an ideal state, when the fan is stopped, the temperature in the computer body 11 is raised. Accordingly, it is not preferable to stop the fan. In the ideal state, it is preferably that the number of rotation of the fan is made as low as possible to suppress a noise.

Hereinafter, a configuration for controlling the number of rotation will be described.

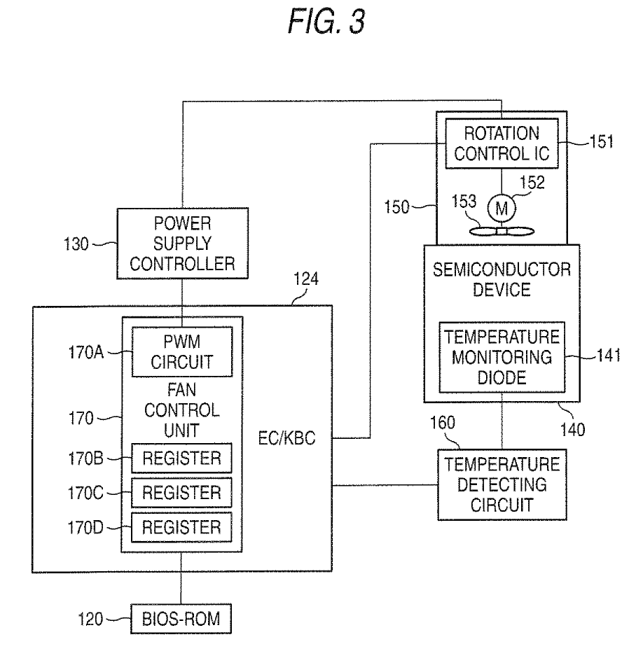

FIG. 3 is a diagram illustrating a configuration for controlling the number of rotation of the fan according to an embodiment of the invention.

As shown in FIG. 3, a cooling fan 150 is mounted on a semiconductor device 140. The cooling fan 150 includes a rotation control IC 151, a motor 152, and a fan 153. An operation voltage supplied from a power supply controller 130 is supplied through the rotation control IC 151 to the motor 152, thereby rotating the fan 153. The number of rotation of the fan 153 is monitored by the rotation control IC 151. The rotation control IC 151 supplies a pulse signal according to the number of rotation of the fan 153 to the EC/KBC 124.

In the semiconductor device 140, a temperature measuring diode 141 is provided. A temperature measuring diode 160 allows static current to flow into the temperature measuring diode 141, and measures a forward voltage drop of the temperature measuring diode 141 at that time. A temperature detecting circuit 160 calculates a temperature at a position, where the temperature measuring diode 141 of the semiconductor device 140 is formed, on the basis of temperature characteristics of the forward voltage drop of the temperature measuring diode 141. The calculated temperature is supplied to the EC/KBC 124.

The EC/KBC 124 controls an operation voltage value supplied from the power supply controller 130 to the rotation control IC 151 of the cooling fan 150, to control the number of rotation of the fan 153 of the cooling fan 150 according to the temperature detected by the temperature detecting circuit 160.

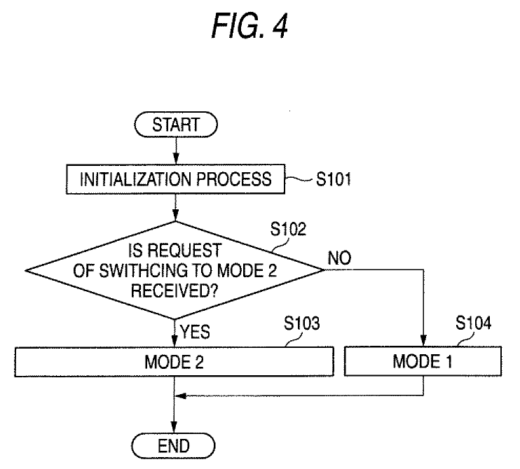

In the BIOS-ROM 120, the number of rotation of the fan 153 according to the temperature is stored. FIG. 4 shows the number of rotation of the fan 153 according to the temperature.

In the EC/KBC 124, a characteristic expression indicating an operation voltage with respect to the number of rotation is stored. The EC/KBC 124 acquires the number of rotation corresponding to the measured temperature from the BIOS-ROM 120, calculates an operation voltage value of the cooling fan 150 from the acquired number of rotation and the characteristic expression, and registers voltage appointment information corresponding to the voltage value in an operation voltage value register 170B of the fan control unit 170. A PWM circuit 170A provided in the fan control unit 170 generates a PWM (pulse width modulation) signal corresponding to the registered voltage appointment information, and supplies the PWM signal to the power supply controller 130. The PWM signal indicates a level of the operation voltage with a pulse width. Since the level of the operation voltage is indicated with the pulse width, the operation voltage value is 0 when the PWM signal is not output, that is, when the signal is “0”. In the BIOS-ROM 120, PWM signal appointment information indicating PWM signals corresponding to voltages formed by dividing 0 to 5 V is set. The PWM circuit 170A reads out the PWM signal appointment information corresponding to the voltage appointment information registered in the operation voltage value register 170B, and supplies the PWM signal corresponding to the read PWM signal appointment information to the power supply controller 130.

In the present embodiment, the number of rotation of the fan 153 is controlled using the following two modes.

There are provided a mode 1 of controlling the fan 153 corresponding to the temperature detected by the temperature detecting circuit 160 in the range from a step state (the number of rotation: 0) to a predetermined number of rotation, and a mode 2 of controlling the fan 153 to have the number of rotation fixed smaller than the predetermined number of rotation (4000 rotation/minute), for example, 1500 rotation/minute. The mode 1 and the mode 2 are switchable at a predetermined time by a user.

In the mode 1, the number of rotation of the fan 153 is controlled corresponding to the temperature detected by the temperature detecting circuit 160. In case of a low-load process of the computer 10, for example, in case of a long-time display process of text or the like, the temperature of the semiconductor device 140 does not rise, for example, lower than 44° C. Accordingly, the number of rotation of the fan 153 is made into 0 rpm, and the rotation of the fan 153 is stopped.

In the mode 2, the fan 153 is rotated constantly at the fixed number of rotation, irrespective of the temperature detected by the temperature detecting circuit 160. This number of rotation is smaller than the predetermined number of rotation (4000 rotation/minute) that is the number of rotation in the mode 1, for example, the fixed number of rotation of 1500 rotation/minute.

Hereinafter, a fan control method applying the information processing apparatus according to the embodiment of the invention will be described with reference to FIG. 4. In the present embodiment, although the case of operating the computer 10 with electric power supplied from a battery 125A is described, the same is applicable even in case of operating the computer 10 with electric power supplied from an AC adaptor 125B.

The CPU 111 performs initialization in case of operating the computer 10 by the battery 125A (Step S101). Then, when the CPU 111 receives a request of switching to the mode 2 (Step S102: YES), the CPU 111 performs switching to the mode 2 (Step S103). When the request of switching to the mode 2 is not received (Step S102: NO), the CPU 111 performs setup as the mode 1 that is a normal mode (Step S104).

As described above, there are provided two switchable modes of the mode 1 and the mode 2. In the mode 2, since the fan 153 is rotated constantly at the fixed number of rotation irrespective of the temperature detected by the temperature detecting circuit 160, it is possible to suppress a noise caused by change of the number of rotation of the fan 153 and a noise caused by stoppage and restart of the fan 153. In addition, since the fan 153 is constantly rotated at a constant low speed, it is possible to suppress heat radiation even at the time when precipitous load occurs by the semiconductor device 140. In the mode 1, it is possible to suppress power consumption by stopping the fan 153 in case where the devices are continuously in a low-load state due to a display process of text or the like.

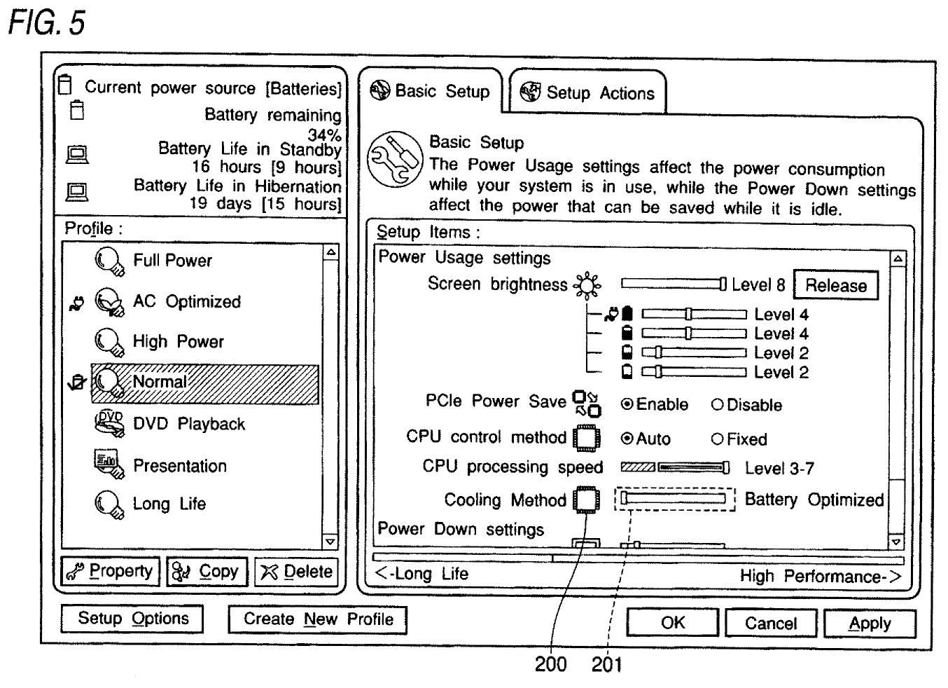

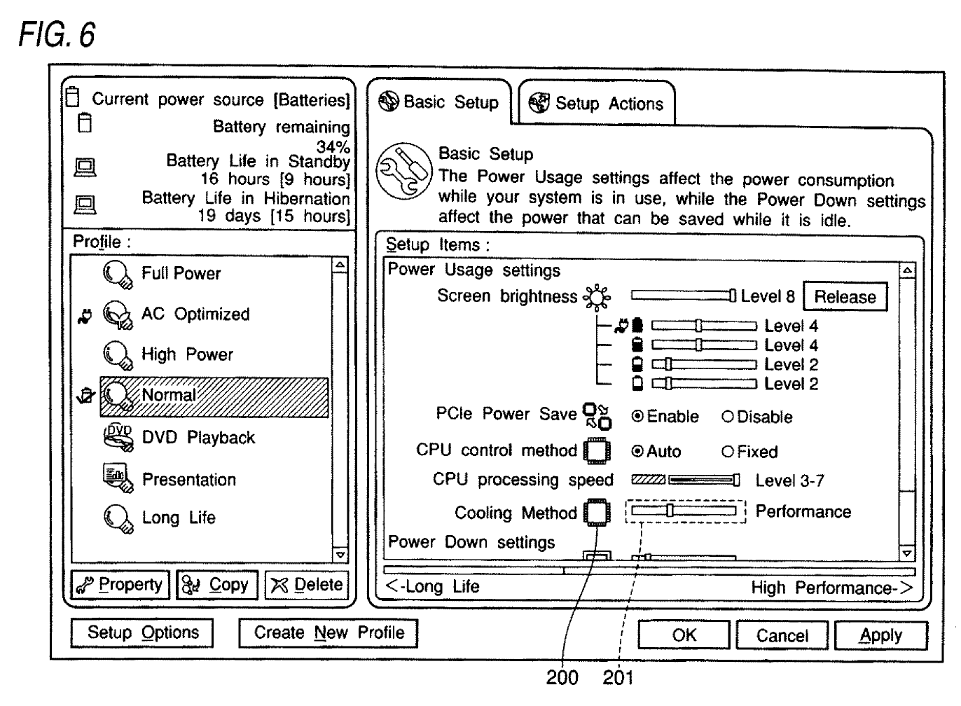

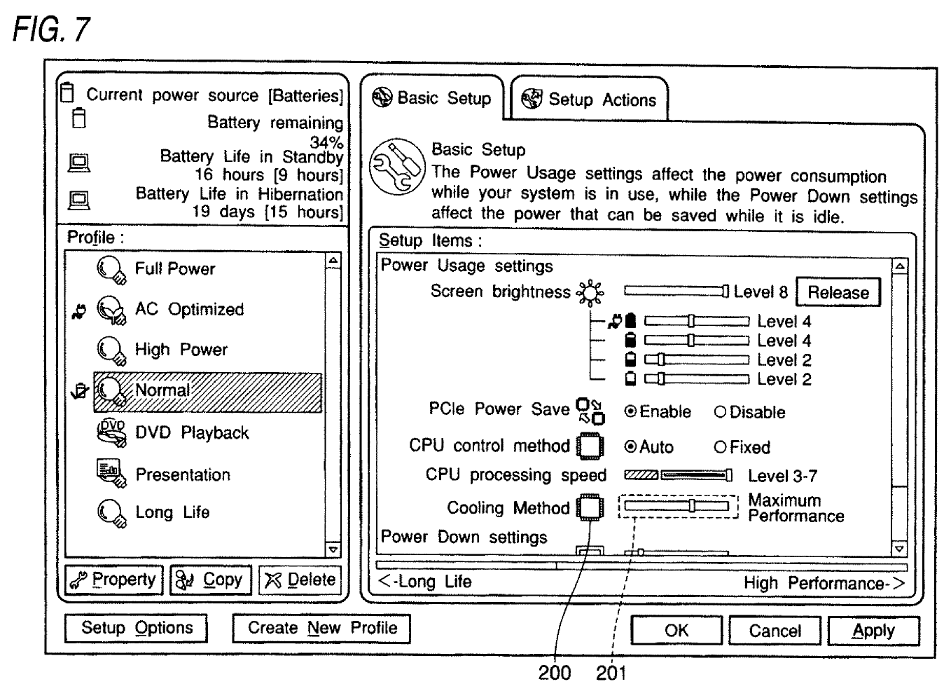

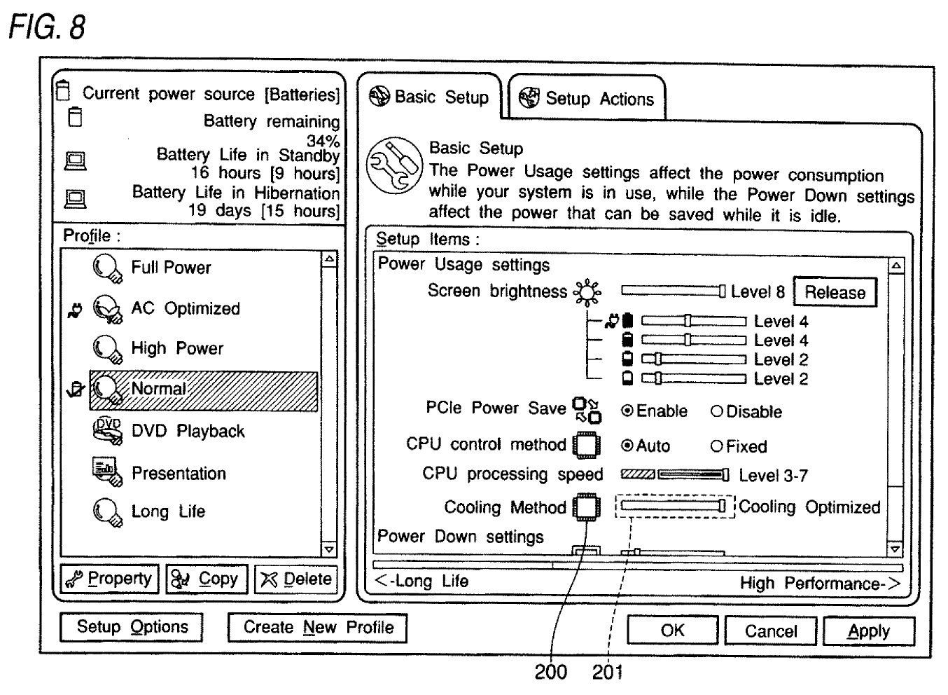

Next, setup of a utility for fan control will be described with reference to FIGS. 5 to 9. In the setup of control of the above-described fan 153, for example, an exclusive utility shown in FIG. 5 is used. In the control utility, setup is performed with respect to Cooling Method 200 in setup items. For example, the setup is changeable by moving a setup bar 201 left and right. In this setup, the following levels may be set up: Battery Optimized (see FIG. 5); Performance (see FIG. 6); Maximum Performance (see FIG. 7); and Cooling Optimized (see FIG. 8). In the present embodiment, for example, when Battery Optimized is selected, the mode 1 is set up, and when other Performance, Maximum Performance, or Cooling Optimized is selected, the mode 2 is set up.

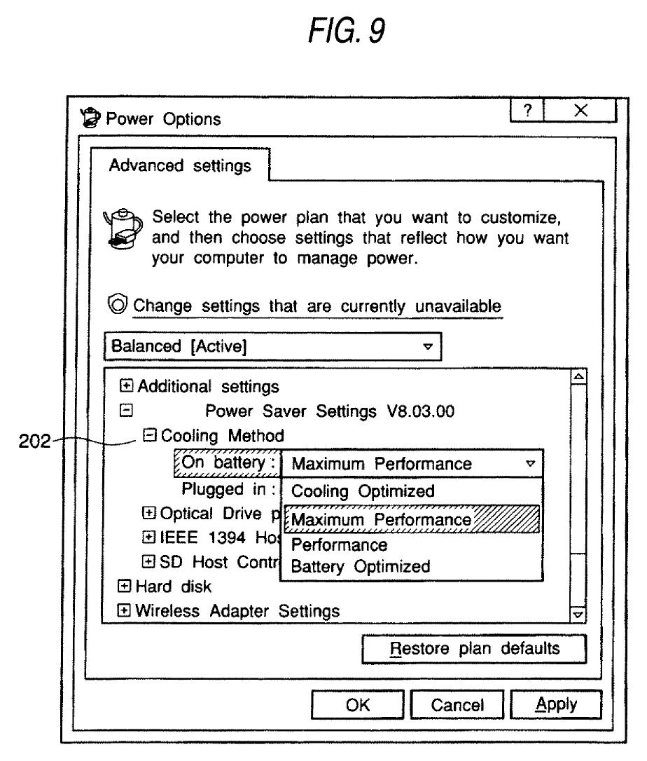

As shown in FIG. 9, the setup may be performed using another utility. For example, setup is performed with respect to Cooling Method 202 in setup items. The setup is changeable by selecting a pull-down menu 202. Similarly with the aforementioned utility, for example, when Battery Optimized is selected, the mode 1 is set up, and when other Performance, Maximum Performance, or Cooling Optimized is selected, the mode 2 is set up.

The invention is not limited to the above-described embodiments. In the realizing step, the invention may be embodied by modifying constituent elements within the scope of the idea of the invention.

In addition, various inventions may be made by suitably combining the plurality of constituent elements disclosed in the above-described embodiments. For example, some of the constituent elements may be eliminated from the whole constituent elements represented in the embodiments. In addition, constituent elements over another embodiment may be suitably combined.

As described with reference to the embodiment, there is provided an information processing apparatus and a fan control method capable of reducing the noise harsh to user's ears by a mode in which the cooling fan is continuously operated by fixing the number of rotation at a low speed, and a fan control method of stopping the cooling fan in case where the devices are continuously in a low-load state due to a display process of text or the like.

What is claimed is:

1. An information processing apparatus comprising:
a case;
a device that is housed in the case;
a cooling fan that cools the device;
a temperature detecting device that detects a temperature of the device; and
a controller that is operable in a first mode and second mode, the first mode controlling the cooling fan in a range from a stopped state to a given rotation speed in accordance with the temperature detected by the temperature detecting device, and a second mode controlling the cooling fan to rotate at a predetermined rotation speed that is lower than the given rotation speed.

2. The apparatus according to claim 1, wherein the control unit is switchable between the first mode and the second mode at a given timing.

3. The apparatus according to claim 1, wherein the controller operates in the second mode when the apparatus is powered by a battery.

4. The apparatus according to claim 1, wherein the device includes a processor, and
wherein the controller operates in the first mode when processor load is lower than given load.

5. A method for controlling a cooling fan provided in an information processing apparatus having a case, a device housed in the case, the cooling fan cooling the device and a temperature detecting device detecting a temperature of the device, the method comprising:
detecting a temperature of the device; and
switching a first mode and second mode, the first mode controlling the cooling fan in a range from a stopped state to a given rotation speed in accordance with the temperature, and a second mode controlling the cooling fan to rotate at a predetermined rotation speed that is lower than the given rotation speed.

6. The apparatus according to claim 5, wherein the controller operates in the second mode when the apparatus is powered by a battery.

7. The apparatus according to claim 1, wherein the device includes a processor, and
wherein the controller operates in the first mode when processor load is lower than given load.
